(19) United States
(12) Patent Application Publication
(10) Pub. No.: US 2014/0286442 A1
(43) Pub. Date: Sep. 25, 2014

(54) APPARATUS AND METHOD FOR IN-LOOP FILTERING BASED ON LARGEST CODING UNIT FOR REDUCING EXTERNAL MEMORY ACCESS BANDWIDTH

(71) Applicants: KWANGWOON UNIVERSITY INDUSTRY-ACADEMIC COLLABORATION FOUNDATION, Seoul (KR); SAMSUNG ELECTRONICS CO., LTD., Suwon-si (KR)

(72) Inventors: Doo Hyun Kim, Seoul (KR); Dong Gyu Sim, Seoul (KR); Do Hyung Kim, Hwaseong-si (KR); Joon Ho Song, Hwaseong-si (KR); Eun Kyung Ryu, Seoul (KR); Shi Hwa Lee, Seoul (KR); Hyun Ho Cho, Seoul (KR); Jong Hun Yoo, Seoul (KR)

(73) Assignees: KWANGWOON UNIVERSITY INDUSTRY-ACADEMIC COLLABORATION FOUNDATION, Seoul (KR); SAMSUNG ELECTRONICS CO., LTD., Suwon-si (KR)

(21) Appl. No.: 14/079,071

(22) Filed: Nov. 13, 2013

(30) Foreign Application Priority Data
Mar. 25, 2013 (KR) 10-2013-0031370

(51) Int. Cl. H04N 19/80

(52) U.S. Cl. CPC H04N 19/0089
USPC 375/240.29

(57) ABSTRACT

An apparatus and method for in-loop filtering based on a largest coding unit (LCU) to reduce an external memory access bandwidth. An in-loop filter may include an external memory to store decoded frames, an internal memory to store pixels in use for deblocking filtering and sample adaptive offset filtering, a horizontal deblocking filter to perform deblocking filtering on input pixels in a horizontal direction with respect to vertical edge boundaries within an input area, a vertical deblocking filter to perform deblocking filtering in a vertical direction with respect to horizontal edge boundaries within the input area, and a sample adaptive offset filter to perform sample adaptive offset filtering.

### CROSS-REFERENCE TO RELATED APPLICATIONS

This application claims the priority benefit of Korean Patent Application No. 10-2013-0031370, filed on Mar. 25, 2013, in the Korean Intellectual Property Office, the disclosure of which is incorporated herein by reference.

### BACKGROUND

1. Field

The following description relates to a technology for deblocking filtering and sample adaptive offset filtering with reduced external memory access in a high efficiency video coding (HEVC) video decoder.

2. Description of the Related Art

High efficiency video coding (HEVC) is a next-generation video codec currently under development by a joint collaborative team on video coding (JCT-VC), a group of video coding experts from moving picture experts group (MPEG) and video coding experts group (VCEG).

HEVC may not rely on macroblock-based coding, dissimilar to video codecs based on standards up to and including H.264/Advanced Video Coding (AVC). Macroblock-based coding may not be able to process images of various resolutions effectively due to a fixed macroblock size. To resolve this issue, HEVC defines a coding unit (CU), a transform unit (TU), and a prediction unit (PU), and among them, uses a CU as a basic coding unit. A CU having a largest size is referred to as a largest coding unit (LCU), and after an input image is divided into a plurality of LCUs, coding and decoding is performed based on LCUs.

An HEVC decoder performs deblocking filtering on a reconstructed image, followed by sample adaptive offset filtering. In the HEVC decoder, deblocking filtering and sample adaptive offset filtering may be performed based on LCUs or frames. In a case in which deblocking filtering and sample adaptive offset filtering are performed based on frames, after an image is reconstructed based on frames, deblocking filtering and sample adaptive offset filtering is performed on the reconstructed frames.

When in-loop filtering is performed based on frames, all reconstructed LCUs cannot be stored in an internal memory. In this instance, an external memory is used. For deblocking filtering and sample adaptive offset filtering, the reconstructed pixels are loaded from an external memory into an internal memory. As a result, an external memory access bandwidth is increased, and consequently, system performance deteriorates.

### SUMMARY

The foregoing and/or other aspects are achieved by providing an in-loop filter including an external memory to store decoded frames, an internal memory to store pixels in use for deblocking filtering and sample adaptive offset filtering, a horizontal deblocking filter to perform deblocking filtering on input pixels in a horizontal direction with respect to vertical edge boundaries within an input area, using a largest coding unit (LCU) and pixels adjacent to the LCU among the pixels stored in the internal memory, a vertical deblocking filter to perform deblocking filtering in a vertical direction with respect to horizontal edge boundaries within the input area, using the pixels to which the deblocking filtering is applied in the horizontal direction, and a sample adaptive offset filter to perform sample adaptive offset filtering using the pixels to which the deblocking filtering is applied in the horizontal direction within the input area.

The vertical deblocking filter may perform the deblocking filtering using pixels located on a left side portion, an upper left side portion, and an upper side portion of the LCU among the pixels adjacent to the LCU.

The external memory may store reference pixel values to be used for in-loop filtering when the in-loop filtering is performed based on LCUs.

The internal memory may load pixels used for filtering from the external memory, based on LCUs when a high efficiency video coding (HEVC) decoder performs deblocking filtering and sample adaptive offset filtering based on frames in a sequential order, after performing image reconstruction based on frames.

The internal memory may store a portion of the pixels within the LCU to be used for in-loop filtering of a next LCU.

The external memory may store a portion of the pixels within the LCU to be used for in-loop filtering of a next LCU in a case in which there is a size limit of the internal memory.

At least one memory of the internal memory and the external memory may store a pixel area to be referred to for performing the deblocking filtering and the sample adaptive offset filtering, and may re-use the stored pixel area.

At least one memory of the internal memory and the external memory may back up a pixel area having a size determined based on an LCU height or an LCU width.

At least one memory of the internal memory and the external memory may back up a pixel area having a size determined based on an LCU height in a right side portion of the LCU, or a pixel area having a size determined based on an LCU width in a bottom of the LCU.

At least one memory of the internal memory and the external memory may back up a pixel area having a size determined based on an LCU height in a right side portion of the LCU, using a double buffer.

At least one memory of the internal memory and the external memory may back up a pixel area having a size determined based on an LCU width in a bottom of the LCU, using at least one of a double buffer and a triple buffer.

At least one memory of the internal memory and the external memory may store a line buffer, at least one of the horizontal deblocking filter and the vertical deblocking filter may perform deblocking filtering based on LCUs using the line buffer, and the sample adaptive offset filter may perform sample adaptive offset filtering based on LCUs.

At least one memory of the internal memory and the external memory may store an area having a size determined based on an image width in the line buffer, and may update the line buffer per line of the LCU.

The foregoing and/or other aspects are achieved by providing an in-loop filtering method including storing, using an external memory, decoded frames, storing, using an internal memory, pixels in use for deblocking filtering and sample adaptive offset filtering, performing, using a horizontal deblocking filter, deblocking filtering on input pixels in a horizontal direction with respect to vertical edge boundaries within an input area, using an LCU and pixels adjacent to the LCU among the pixels stored in the internal memory, performing, using a vertical deblocking filter, deblocking filtering in a vertical direction with respect to horizontal edge boundaries within the input area, using the pixels to which the deblocking filtering in the horizontal direction is applied, and performing, using a sample adaptive offset filter, sample adaptive offset filtering using the pixels to which the deblocking filtering in the horizontal direction is applied within the input area.

The deblocking filtering in the vertical direction may include performing the deblocking filtering using pixels located on a left side portion, an upper left side portion, and an upper side portion of the LCU among the pixels adjacent to the LCU.

The method may further include storing, using the external memory, reference pixel values to be used for in-loop filtering when the in-loop filtering is performed based on LCUs.

The method may include loading, using the internal memory, pixels used for filtering from the external memory, based on LCUs when an HEVC decoder performs deblocking filtering and sample adaptive offset filtering based on frames in a sequential order, after reconstructing an image based on frames.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates largest coding units (LCUs), into which a slice or a frame is divided, for deblocking filtering in high efficiency video coding (HEVC), and adjacent pixels to be referred to for each LCU during deblocking filtering;

FIG. 2 illustrates LCUs, into which a slice or a frame is divided, for sample adaptive offset filtering in HEVC, and adjacent pixels to be referred to for each LCU during sample adaptive offset filtering;

FIG. 3 illustrates an in-loop filter according to an exemplary embodiment;

FIG. 4 illustrates an area for loading from an external memory into an internal memory for in-loop filtering based on LCUs in the in-loop filter of FIG. 3;

FIG. 5 illustrates an area for backing up a reference pixel group to an internal memory for in-loop filtering based on LCUs in the in-loop filter of FIG. 3;

FIG. 6 illustrates a configuration of an internal memory in the in-loop filter of FIG. 3;

FIG. 7 illustrates pixels used as inputs for a horizontal deblocking filter, a vertical deblocking filter, and a sample adaptive offset filter in the in-loop filter of FIG. 3;

FIG. 8 illustrates an example of deblocking filtering in a horizontal direction with respect to a vertical edge boundary of an input area in a horizontal deblocking filter;

FIG. 9 illustrates an example of deblocking filtering in a vertical direction with respect to a horizontal edge boundary of an input area in a vertical deblocking filter;

FIG. 10 illustrates an example of sample adaptive offset filtering of an input area in a sample adaptive offset filter;

FIG. 11 illustrates an area for storing from an internal memory to an external memory after deblocking filtering and sample adaptive offset filtering based on LCUs in the in-loop filter of FIG. 3;

FIG. 12 illustrates a method for deblocking filtering and sample adaptive offset filtering according to an exemplary embodiment;

FIG. 13 illustrates a configuration of an internal memory and an external memory in the in-loop filter of FIG. 3 according to another exemplary embodiment; and

FIG. 14 illustrates a method for deblocking filtering and sample adaptive offset filtering according to another exemplary embodiment.

### DETAILED DESCRIPTION

Embodiments herein and the various features and advantageous details thereof are explained more fully with reference to non-limiting embodiments that are illustrated in the accompanying drawings and detailed in the following description.

Descriptions of well-known components and processing techniques are omitted so as not to unnecessarily obscure the embodiments herein. The examples used herein are intended merely to facilitate an understanding of ways in which embodiments herein may be practiced and to further enable those of skill in the art to practice embodiments herein. Accordingly, the examples should not be construed as limiting the scope of embodiments herein. Like reference numerals refer to the like components throughout.

Exemplary embodiments relate to an in-loop filtering technology to reduce an external memory access bandwidth in the design of a high efficiency video coding (HEVC) decoder. More particularly, exemplary embodiments disclose a technique for deblocking filtering and sample adaptive offset filtering with reduced external memory access by implementing image reconstruction, deblocking filtering, and sample adaptive offset filtering based on largest coding units (LCUs) in a sequential order.

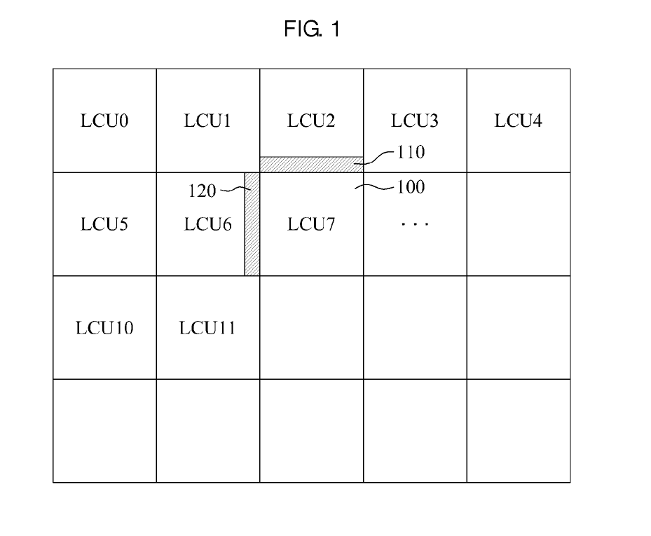

FIG. 1 illustrates adjacent pixels to be referred to for each LCU during deblocking filtering based on LCUs in an HEVC video decoder.

Referring to FIG. 1, an HEVC video decoder may perform, using an in-loop filter, deblocking filtering on LCUs, into which a frame or a slice is divided for each LCU. Deblocking filtering of an LCU 100 to be filtered may be implemented by performing deblocking filtering of a vertical edge boundary and a horizontal edge boundary of the LCU 100 by referring to pixel information 110 of an LCU located in an upper side portion of the LCU 100 and pixel information 120 of an LCU located on a left side portion of the LCU 100.

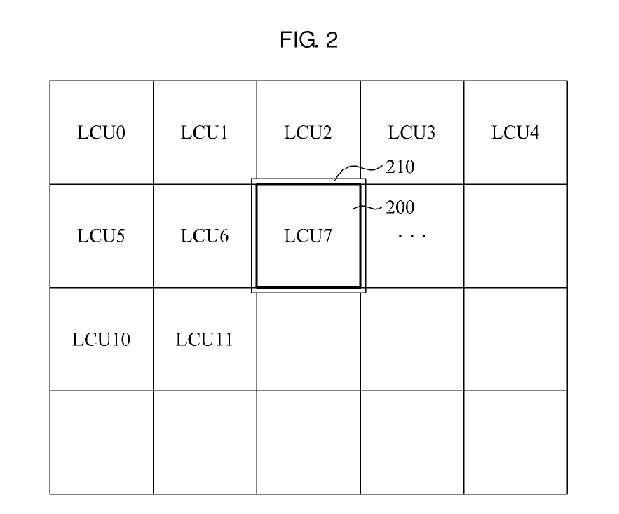

FIG. 2 illustrates adjacent pixels to be referred to for each LCU during sample adaptive offset filtering based on LCUs in an HEVC video decoder.

Referring to FIG. 2, an HEVC video decoder may perform, using an in-loop filter, sample adaptive offset filtering on LCUs into which a frame or a slice is divided, for each LCU. In the sample adaptive offset filtering of an LCU 200 to be filtered, reference may be made to pixel information 210 of a plurality of directions, for example, eight directions, adjacent to the LCU 200. In particular, in edge offset type filtering of the sample adaptive offset filtering in HEVC, the pixel information 210 of eight directions adjacent to the LCU 200 may be used for category selection.

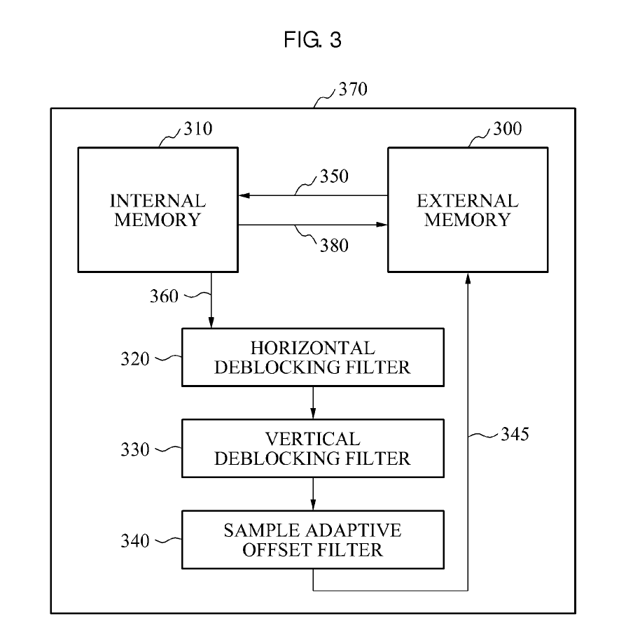

FIG. 3 illustrates an in-loop filter 370 according to an exemplary embodiment.

Referring to FIG. 3, the in-loop filter 370 according to an exemplary embodiment may include an external memory 300, an internal memory 310, a horizontal deblocking filter 320, a vertical deblocking filter 330, and a sample adaptive offset filter 340.

The external memory 300 may store frames decoded by a decoder. In a case in which in-loop filtering is performed based on LCUs, the external memory 300 may store reference pixel values used for in-loop filtering.

The internal memory 310 may store pixels used for deblocking filtering and sample adaptive offset filtering.

In a case in which an HEVC decoder using the in-loop filter 370 performs image reconstruction based on frames and performs deblocking filtering and sample adaptive offset filtering in a sequential order, pixels used for filtering may be loaded from the external memory 300 to the internal memory 310 based on LCUs.

In a case in which the HEVC decoder using the in-loop filter 370 performs image reconstruction based on LCUs and performs deblocking filtering and sample adaptive offset filtering in a sequential order, the reconstructed LCUs may be previously stored in an internal memory. In this case, loading of pixels from the external memory 300 to the internal memory 310 based on LCUs may not be performed.

A portion of pixels of an LCU to which in-loop filtering is applied may be used for in-loop filtering of a next LCU, and these pixel values may be stored in the internal memory 310. In a case in which there may be a size limit of the internal memory 310, the pixel values may be stored in the external memory 300.

The horizontal deblocking filter 320 may perform deblocking filtering on input pixels in a horizontal direction with respect to vertical edge boundaries within an input area, using the LCU and pixels adjacent to the LCU among the pixels stored in the internal memory 310.

For example, the horizontal deblocking filter 320 may receive, as an input, a target LCU for deblocking filtering and pixels located on a left side portion, an upper left side portion, and an upper side portion of the LCU from the internal memory 310. The horizontal deblocking filter 320 may perform deblocking filtering in a horizontal direction with respect to vertical edge boundaries within an input area.

The vertical deblocking filter 330 may perform deblocking filtering in a vertical direction with respect to horizontal edge boundaries within an input area, using pixels on which deblocking filtering in a horizontal direction is performed.

For example, the vertical deblocking filter 330 may receive, as an input, pixels on which deblocking filtering in a horizontal direction is performed by the horizontal deblocking filter 320. The vertical deblocking filter 330 may perform deblocking filtering in a vertical direction with respect to horizontal edge boundaries within an input area.

The sample adaptive offset filter 340 may perform sample adaptive offset filtering using pixels on which deblocking filtering is performed in a horizontal direction within an input area.

More particularly, the sample adaptive offset filter 340 may receive, as an input, pixels on which deblocking filtering in a horizontal direction is performed by the vertical deblocking filter 330. The vertical deblocking filter 330 may receive, as an execution input, deblocking filtering in a vertical direction with respect to horizontal edge boundaries within an input area.

The sample adaptive offset filter 340 may perform sample adaptive offset filtering on pixels of an input area. The sample adaptive offset filter 340 may apply sample adaptive offset filtering to an input area, and may store the area, to which sample adaptive offset filtering is applied, in the external memory 300.

Accordingly, using the in-loop filter 370 according to an exemplary embodiment, deblocking filtering and sample adaptive offset filtering may be performed individually using an LCU to be filtered and pixels values of, for example, a left side portion, an upper left side portion, and an upper side portion of the LCU when deblocking filtering and sample adaptive offset filtering are performed based on LCUs.

Also, using the in-loop filter 370, an error caused by unprepared pixel values adjacent to an LCU to be decoded due to a decoding order may be corrected automatically during filtering an adjacent LCU by using a method of storing a block having a size of “(LCU height+4)×(LCU width+4)”.

The in-loop filter 370 may reduce an external memory access bandwidth and may improve system performance, by performing image reconstruction, deblocking filtering, and sample adaptive offset filtering based on LCUs.

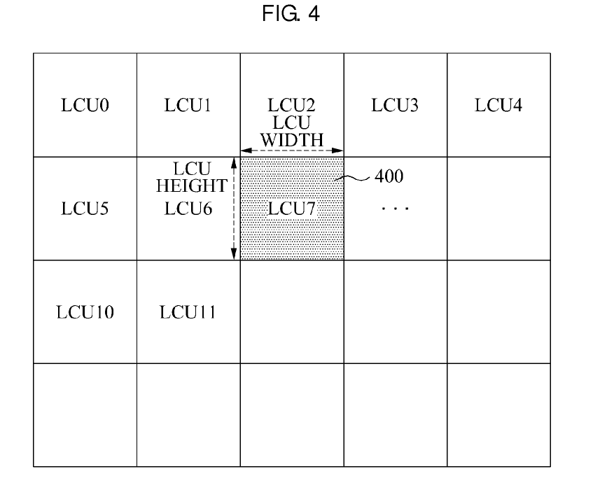

FIG. 4 illustrates a pixel area to load 350 from the external memory 300 to the internal memory 310 for in-loop filtering based on LCUs in the in-loop filter 370 of FIG. 3.

In a case in which an HEVC decoder using an in-loop filter performs image reconstruction based on frames, a succession of deblocking filtering and sample adaptive offset filtering may be performed on pixels stored in an external memory again. When an image is reconstructed based on frames, the reconstructed pixels may be generally stored in an external memory because all pixels of the frames may not be stored in an internal memory. Accordingly, in a case in which an image is reconstructed based on frames, an LCU 400 to be filtered may be first loaded into the internal memory 310 for deblocking filtering and sample adaptive offset filtering.

Also, in a case in which adjacent pixels used to perform deblocking filtering and sample adaptive offset filtering on the LCU 400 are stored in an external memory, adjacent reference pixel values to which in-loop filtering is not applied may be loaded 350 as well as pixel values 400 of the filtered LCU.

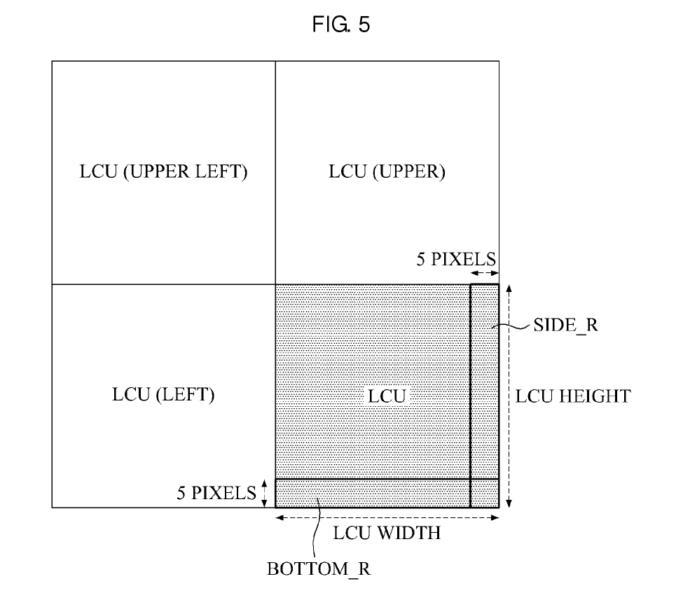

FIG. 5 illustrates a backup of a reference pixel group to the internal memory 310 for deblocking filtering and sample adaptive offset filtering based on LCUs in the in-loop filter 370 of FIG. 3.

Referring to FIG. 5, a deblocking filter in HEVC may perform filtering with respect to an edge boundary. SIDE_R and BOTTOM_R areas among pixels of a target LCU for deblocking filtering may be used for in-loop filtering of LCUs located on a right side portion and a bottom of the current LCU. Accordingly, before deblocking filtering of the LCU in HEVC, the pixels of the corresponding area may be backed up to an internal or external memory.

In the in-loop filter 370 of FIG. 3, the pixel values of the target LCU may be loaded from the external memory to the internal memory based on LCUs, or may be maintained in the internal memory. Before performing deblocking filtering and sample adaptive offset filtering using the corresponding pixel values, a pixel area to be referred to later, SIDE_R and BOTTOM_R, within the current LCU may be backed up to a buffer of the internal memory, in this example. The SIDE_R area may correspond to an area located at the rightmost of the current LCU, and may have a size of “LCU height×5”. The BOTTOM_R area may correspond to an area located at the bottom of the current LCU, and may have a size of “5×LCU width”.

In a case in which a size of an input image is not sufficiently large to store BOTTOM_R of each LCU in the internal memory line by line, the corresponding area may be stored (380 in FIG. 3) from the internal memory to a buffer of the external memory.

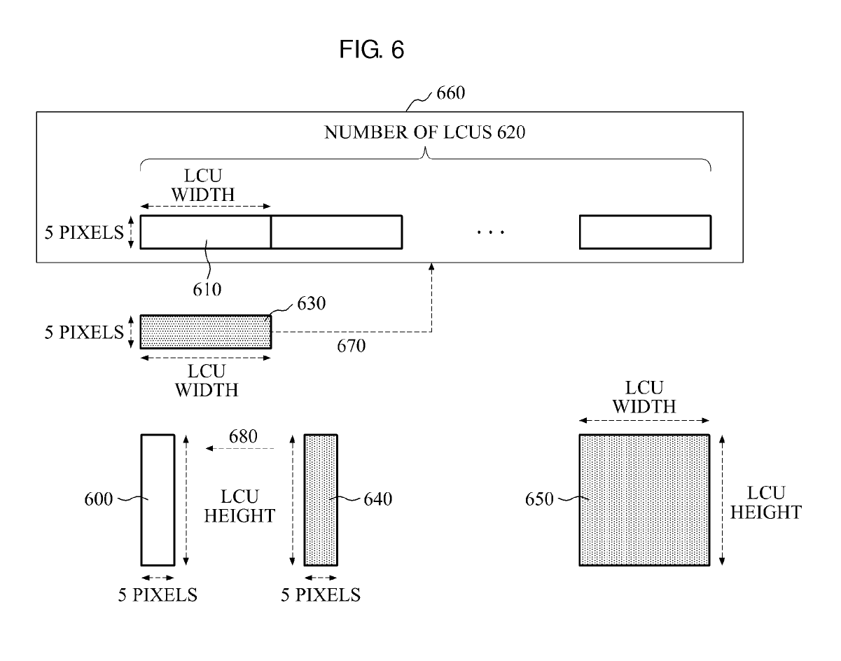

FIG. 6 illustrates a configuration of the internal memory 310 according to an exemplary embodiment.

Referring to FIG. 6, in a case in which deblocking filtering and sample adaptive offset filtering are performed based on LCUs, the internal memory 310 may include a buffer 650 to store pixels of an LCU to be filtered. Also, the internal memory 310 may include a buffer 640 to store SIDE_R of FIG. 5 and a buffer 630 to store BOTTOM_R of FIG. 5 before performing deblocking filtering and sample adaptive offset filtering. Also, the internal memory 310 may include a buffer 600 to store SIDE_R located on a left side portion of the LCU to perform additional filtering.

In the deblocking filtering in HEVC, a portion of pixel information of an LCU located on a left side portion of the LCU may be used in filtering in a vertical direction. To perform deblocking filtering and sample adaptive offset filtering based on LCUs, storing all BOTTOM_R of LCUs located on a minimum of one line may be required. Accordingly, the internal memory may include a line buffer 660 to store a corresponding number of BOTTOM_R areas to a number of LCUs located in a widthwise direction of a frame. For example, when an image having a 1920×1080 resolution to be processed is divided into 64×64 LCUs, the line buffer 660 may store a minimum number of 30(=1920/64) BOTTOM_R.

After in-loop filtering, more particularly, horizontal deblocking filtering, vertical deblocking filtering, and sample adaptive offset filtering, is performed on the input LCU, movement of values may be made between memories. The pixel buffer 640 backed up before filtering the target LCU for in-loop filtering may be copied to the buffer 600 before in-loop filtering for a next LCU.

Also, the pixel values stored in the buffer 630 may be copied to the line buffer 660. A location to which the pixel values are copied in the line buffer 660 may be stored in a buffer corresponding to an index in a direction of an X axis or a horizontal direction of the filtered LCU 650.

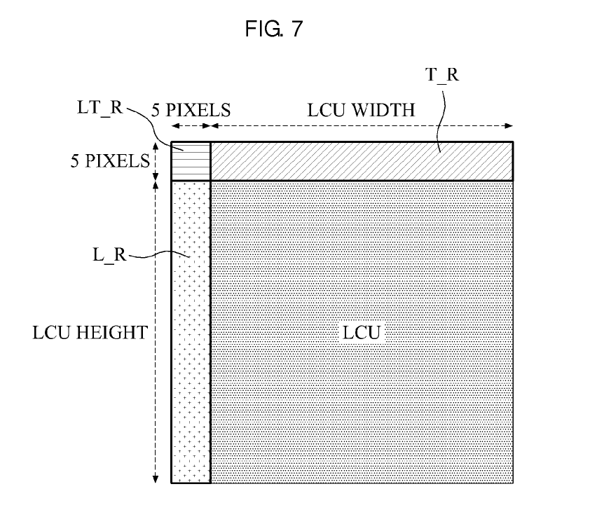

FIG. 7 illustrates pixels used as inputs for the horizontal deblocking filter 320, the vertical deblocking filter 330, and the sample adaptive offset filter 340 in the in-loop filter 370 of FIG. 3.

Referring to FIG. 7, the LCU buffer 650 of the internal memory 310 may be used as an input for an input value of the horizontal deblocking filter 320, and for additional filtering of the LCU, pixels L_R of a left area, pixels LT_R of an upper left area, and pixels T_R of an upper area may be used as an input. The pixels L_R of the left area may have, for example, a size of “LCU height×5”, the pixels LT_R of the upper left area may have a size of “5×5”, and the pixels T_R of the upper area may have a size of “5×LCU width”.

The pixels L_R of the left area may correspond to pixels stored in the buffer 600 of FIG. 6, and may refer to a reconstructed pixel area having a size of “LCU height×5” located on the left side portion of the current LCU in the reconstructed frame or slice.

The pixels T_R of the upper area may correspond to pixels stored in a buffer corresponding to an index in a direction of an X axis or a horizontal direction of the current LCU in the line buffer 660 of FIG. 6. The corresponding pixel area may refer to a reconstructed pixel area having a size of “LCU height×5” located in the left side portion of the current LCU in the reconstructed frame or slice.

The pixels LT_R of the upper left area may correspond to pixels stored in a buffer located on an “X axis index−1” of the current LCU in the line buffer 660 of FIG. 6. The corresponding pixel area may refer to a pixel area having a size of “5×5” located on the upper left side portion of the current LCU in the reconstructed frame or slice.

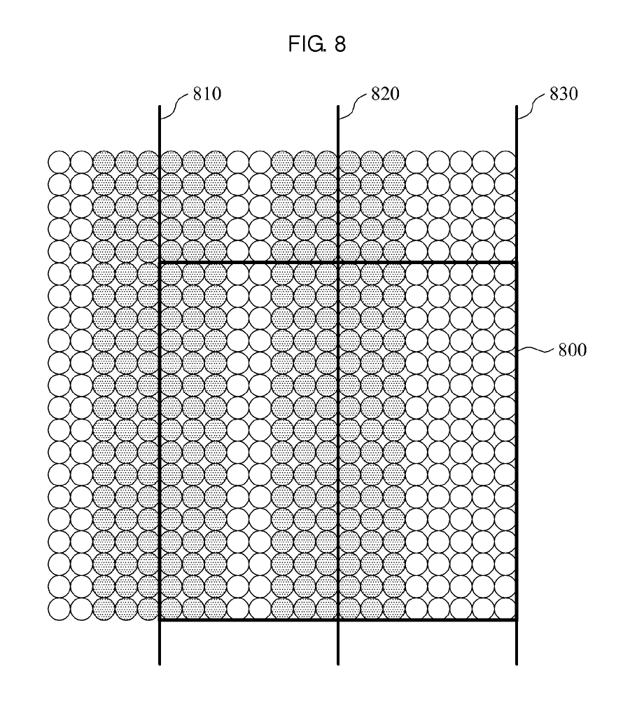

FIG. 8 illustrates an example of deblocking filtering in a horizontal direction with respect to a vertical edge boundary in the horizontal deblocking filter 320 of FIG. 3.

Referring to FIG. 8, the horizontal deblocking filter 320 may receive, as an input, a pixel area having, for example, a size of “(LCU height+5)×(LCU width+5)”.

The deblocking filter in HEVC may perform filtering on an 8×8 block boundary, and may perform filtering by a maximum of three pixels in left and right directions or in upper and lower directions with respect to an edge boundary.

The horizontal deblocking filter 320 may perform filtering on vertical edge boundaries 810 and 820 of an input LCU 800. However, deblocking filtering may not be performed on the corresponding area of the current LCU because a pixel does not exist on a right side portion of a vertical edge boundary 830 located at a rightmost side portion of the LCU 800. In FIG. 8, pixels indicated with shading around the vertical edge boundaries 810 and 820 may represent pixels to which deblocking filtering may be applicable in a horizontal direction with respect to an edge boundary.

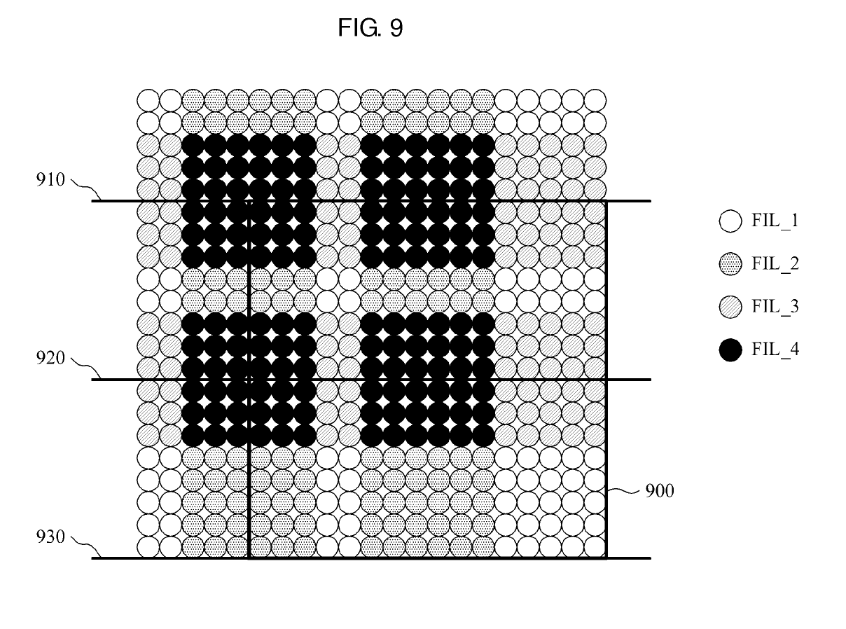

FIG. 9 illustrates an example of deblocking filtering in a vertical direction with respect to a horizontal edge boundary in the vertical deblocking filter 330 of FIG. 3.

Referring to FIG. 9, the vertical deblocking filter 330 may receive, as an input, a pixel area having a size of, for example, “(LCU height+5)×(LCU width+5)” filtered in a horizontal direction by the horizontal deblocking filter 320. With regard to a horizontal edge, the deblocking filter in HEVC may perform filtering on an 8×8 block boundary, and may perform filtering by a maximum of three pixels in upper and lower directions with respect to an edge boundary. The vertical deblocking filter 330 may perform filtering on horizontal edge boundaries 910 and 920 of an input LCU 900, and filtering may not be performed on the corresponding area of the current LCU because a pixel does not exist on a lower side portion of a horizontal edge boundary 930 located at a bottom of the LCU 900.

After the vertical deblocking filter 330 may perform filtering on an input pixel having a size of, for example, “(LCU height+5)×(LCU width+5)” filtered in a horizontal direction by the horizontal deblocking filter 320, result values may include pixels FIL_1 on which deblocking filtering is not performed, pixels FIL_2 on which only horizontal deblocking filtering is performed, pixels FIL_3 on which only vertical deblocking filtering is performed, and pixels FIL_4 on which horizontal and vertical deblocking filtering is performed.

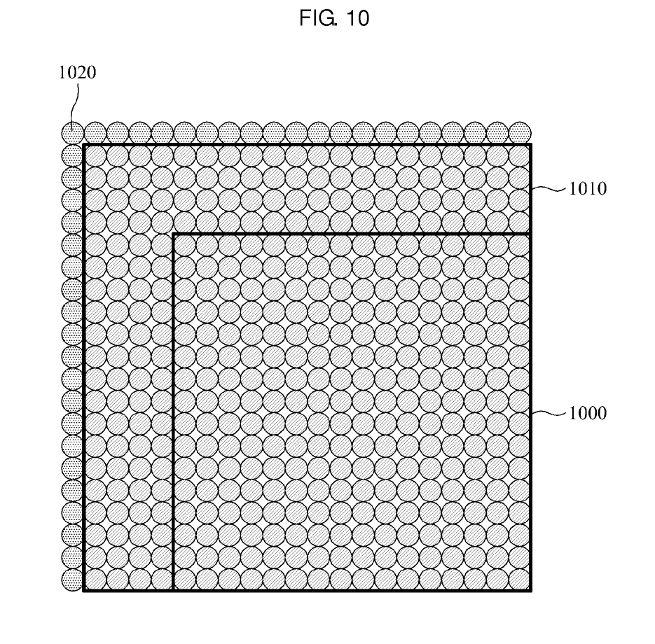

FIG. 10 illustrates an example of sample adaptive offset filtering of an input area in the sample adaptive offset filter 340 of FIG. 3.

Referring to FIG. 10, the sample adaptive offset filter 340 may receive, as an input, a pixel area having a size of “(LCU height+5)×(LCU width+5)” filtered in a vertical direction by the vertical deblocking filter 330.

The sample adaptive offset filter 340 may perform sample adaptive offset filtering on all pixels within an area 1010 having a size of “(LCU height+4)×(LCU width+4)” as well as pixels within an LCU 1000 to be filtered. The sample adaptive offset filtering may be performed on pixels located along left and upper boundaries of the corresponding area 1010 by referring to a pixel value 1020 of an adjacent area. Filtering may be performed under the assumption that reference to pixel values of an adjacent area is difficult with respect to right and lower block boundaries of the area 1010 on which sample adaptive offset filtering is to be performed. Accordingly, a sample adaptive offset filter may not be applied to pixels of the corresponding block boundary.

Accordingly, a portion of pixels of the corresponding area 1010 may have a different value from a result value of sample adaptive offset filtering in HEVC. These pixel values may be replaced with normal pixel values through sample adaptive offset filtering of an adjacent LCU.

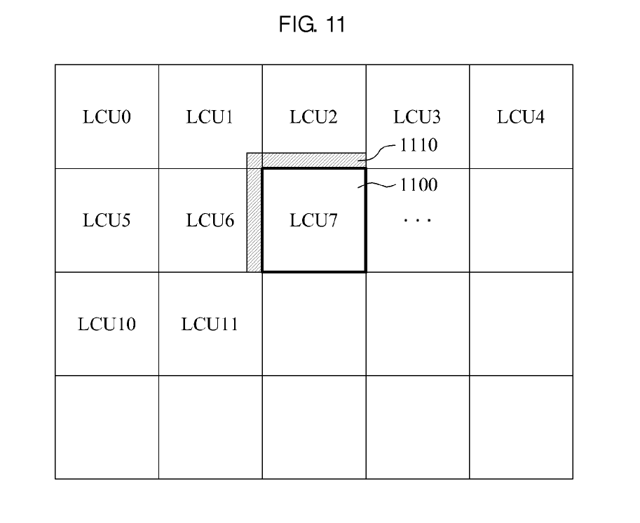

FIG. 11 illustrates an area to store 345 a result value in the external memory 300 after applying the sample adaptive offset filter 340 in the in-loop filter 370 of FIG. 3.

Referring to FIG. 11, the sample adaptive offset filter 340 may perform sample adaptive offset filtering on a pixel area having a size of, for example, “(LCU height+4)×(LCU width+4)” including an LCU 1100 to be filtered, and may store, in the external memory 300, pixels having a size of “LCU height×4” located in a left side portion, pixels having a size of “4×4” located on an upper left side portion, and pixels having a size of “4×LCU width” located on an upper side portion, including the current LCU 1100.

Also, while a result value of in-loop filtering of an adjacent LCU is stored (345 of FIG. 3) in the external memory 300, the in-loop filter 370 may replace error values occurring during deblocking filtering and sample adaptive offset filtering with normal pixel values.

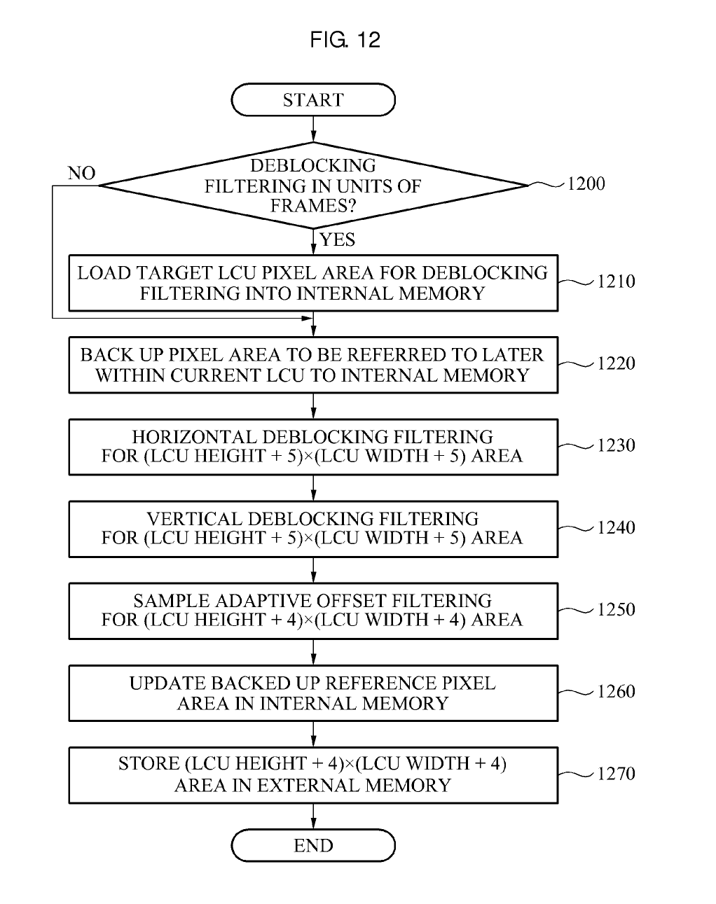

FIG. 12 illustrates a method for deblocking filtering and sample adaptive offset filtering according to an exemplary embodiment.

Referring to FIG. 12, in operation 1200, when performing deblocking filtering and sample adaptive offset filtering based on LCUs, the in-loop filter 370 of FIG. 3 may determine whether deblocking filtering corresponds to frame-based deblocking filtering. The frame-based filtering may refer to a method of deblocking filtering and sample adaptive offset filtering in an HEVC encoder and decoder, involving loading reconstructed pixel values stored in an external memory again after reconstructing an image based on frames. In a case in which deblocking filtering is performed based on frames, reconstructed images may be stored in an external memory. Accordingly, in operation 1210, an LCU to be filtered may be loaded into an internal memory to perform deblocking filtering and sample adaptive offset filtering.

In a case in which deblocking filtering does not correspond to frame-based deblocking filtering, when image reconstruction is performed based on LCUs, followed by deblocking filtering and sample adaptive offset filtering, generally the reconstructed image may be stored in an external memory based on LCUs to minimize an external memory access. Here, loading 1210 of pixels of the LCU from an external memory to an internal memory may not to be performed because the reconstructed LCU is stored in an internal memory.

In operation 1220, after the pixels of the LCU to be filtered are loaded into the internal memory, a pixel area to be referred to later for deblocking filtering and sample adaptive offset filtering of an adjacent LCU prior to filtering may be backed up to the internal memory.

In operation 1230, after a portion of the pixels of the LCU to be filtered are backed up to the internal memory, horizontal deblocking filtering may be performed on an area having a size of, for example, “(LCU height+5)×(LCU width+5)” prepared through the internal memory. For example, in a case in which a frame is divided into LCUs having a size of 64×64, a pixel area having a size of “69×69” may be received as an input and horizontal deblocking filtering may be performed. In operation 1240, after the horizontal deblocking filtering is performed in operation 1230, vertical deblocking filtering may be performed on the same area.

In operation 1250, sample adaptive offset filtering may be performed on an area having a size of, for example, “(LCU height+4)×(LCU width+4)” using the pixels to which the vertical deblocking filtering is applied in operation 1240. In operation 1260, after the sample adaptive offset filtering is performed in operation 1250, the reference pixel area BOTTOM_R backed up to the internal memory before filtering of the current LCU may be updated to the line buffer 660 of the internal memory for future reference by referring to index information of the current LCU, and an update (680 in FIG. 6) of SIDE_R may be performed.

In operation 1270, with respect to the pixel values on which the deblocking filtering and the sample adaptive offset filtering is performed, an area having a size of, for example, “(LCU height+4)×(LCU width+4)” may be stored in the external memory. Through storing in the external memory in operation 1270, a filtering error occurring to a portion of the pixels located in the right side portion and the bottom of the LCU may be replaced with normal pixel values.

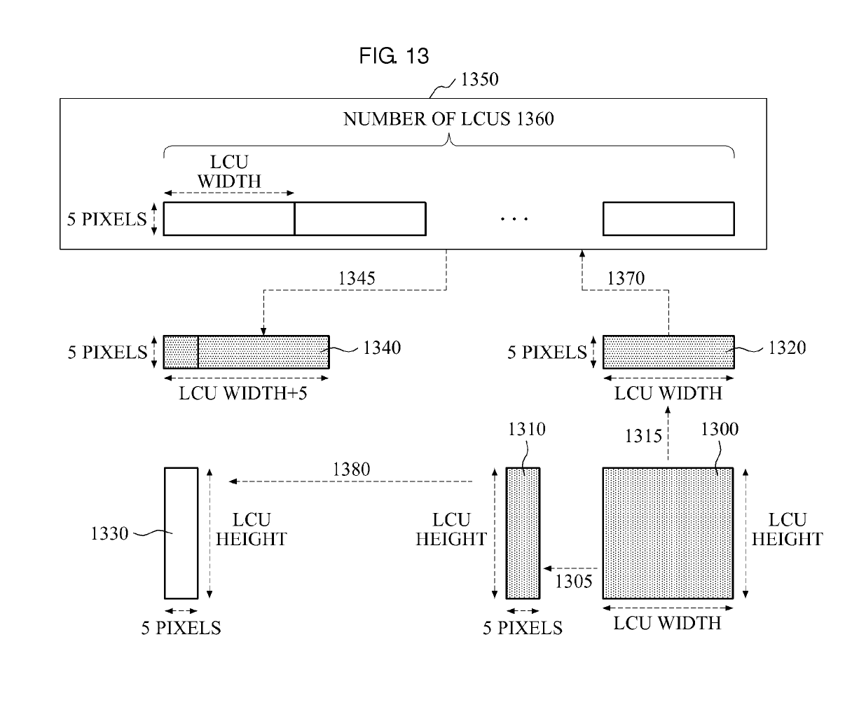

FIG. 13 illustrates a configuration of the internal memory 310 and the external memory 300 in the in-loop filter 370 of FIG. 3.

Referring to FIG. 13, in a case in which it is difficult to store a line buffer 1350 in an internal memory due to a resolution of an input image, the line buffer 1350 may be stored in the external memory 300.

In a case in which the line buffer 1350 is stored in the external memory, when loading pixels 1300 of a target LCU for in-loop filtering, an adjacent pixel area 1340 to be used in in-loop filtering may be also loaded into the external memory. Accordingly, rapid access may be allowed when filtering the current LCU 1300 because the pixel values 1340 of the corresponding area are present in the internal memory.

When in-loop filtering is performed on the current LCU 1300, pixel values of the LCU may be used for filtering a next LCU. Accordingly, backing up of pixel values reconstructed before filtering may be performed. For this purpose, SIDE_R of the current LCU may be backed up 1305 to a buffer 1310 located in the internal memory, and BOTTOM_R of the current LCU may be backed up 1315 to a buffer 1320 located in the internal memory.

When performing in-loop filtering on the current LCU 1300, the in-loop filtering may be performed using a buffer 1330 to store a pixel area located on the left side portion within the LCU before filtering and a buffer 1340 to store a pixel area located in an upper left side portion within the LCU before filtering.

After in-loop filtering for the input current LCU 1300 is completed, SIDE_R and BOTTOM_R backed up for the current LCU may be updated to a buffer.

In the update of the SIDE_R buffer, values of the buffer 1310 located in the internal memory may be stored 1380 in the buffer 1330 located in the internal memory. The BOTTOM_R buffer 1320 of the current LCU 1300 may be stored in the line buffer 1350. When a resolution of the input image is high, the line buffer 1350 may be located in the external memory. In this case, values of the buffer 1320 located in the internal memory may be stored (380 in FIGS. 3 and 1370 in FIG. 13) in the line buffer 1350 located in the external memory. In the line buffer 1350, the values of the buffer 1320 may be stored in a buffer corresponding to an index in a direction of an X axis or a horizontal direction of the filtered LCU 1300.

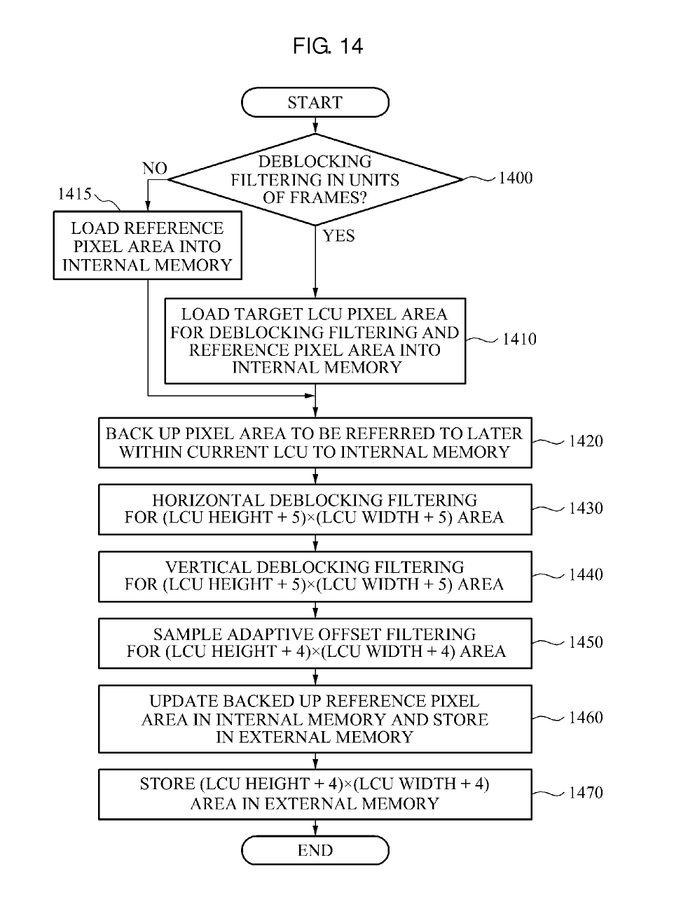

FIG. 14 illustrates a method for deblocking filtering and sample adaptive offset filtering according to another exemplary embodiment.

Referring to FIG. 14, in operation 1400, when performing deblocking filtering and sample adaptive offset filtering based on LCUs, the in-loop filter 370 of FIG. 3 may determine whether deblocking filtering corresponds to frame-based deblocking filtering.

The frame-based filtering may refer to a method of deblocking filtering and sample adaptive offset filtering in an HEVC encoder and decoder, involving loading reconstructed pixel values stored in an external memory after reconstructing an image based on frames. In a case in which deblocking filtering is performed based on frames, reconstructed images may be stored in an external memory. Accordingly, in operation 1410, a pixel area of an LCU to be filtered and a reference pixel area used for in-loop filtering may be loaded into an internal memory to perform deblocking filtering and sample adaptive offset filtering.

In a case in which deblocking filtering does not correspond to frame-based deblocking filtering, when image reconstruction is performed based on LCUs, followed by deblocking filtering and sample adaptive offset filtering, generally the reconstructed image may be stored in an external memory based on LCUs, to minimize an external memory access. Here, loading of pixels of the LCU from an external memory to an internal memory may not to be performed because the reconstructed LCU is stored in an internal memory. However, in operation 1415, the reference pixel area 1340 used for in-loop filtering based on LCUs may be loaded from the line buffer 1350 of the external memory to the internal memory. When the reference pixel area is loaded from the line buffer 1350 located in the external memory, pixel values may be loaded from a buffer corresponding to an index in a direction of an X axis or a horizontal direction of the LCU to be filtered and an “X axis index−1”.

In operation 1420, after the pixels of the LCU to be filtered and the reference pixel area are loaded into the internal memory, a pixel area to be referred to later for deblocking filtering and sample adaptive offset filtering of an adjacent LCU prior to filtering may be backed up to the internal memory.

In operation 1430, after a portion of the pixels of the LCU to be filtered are backed up to the internal memory, horizontal deblocking filtering may be performed on an area having a size of, for example, “(LCU height+5)×(LCU width+5)” prepared through the internal memory. For example, in a case in which a frame is divided into LCUs having a size of 64×64, a pixel area having a size of “69×69” may be received as an input and horizontal deblocking filtering may be performed. In operation 1440, after the horizontal deblocking filtering is performed in operation 1230, vertical deblocking filtering may be performed on the same area.

In operation 1450, sample adaptive offset filtering may be performed on an area having a size of, for example, “(LCU height+4)×(LCU width+4)” using the pixels to which the vertical deblocking filtering is applied in operation 1440. In operation 1460, after the sample adaptive offset filtering is performed in operation 1450, the reference pixel area BOTTOM_R backed up to the internal memory before filtering of the current LCU may be updated to the line buffer 1350 of the external memory for future reference by referring to index information of the current LCU, and an update (1380 in FIG. 13) of SIDE_R may be performed.

In operation 1470, with respect to the pixel values on which the deblocking filtering and the sample adaptive offset filtering is performed, an area having a size of “(LCU height+4)×(LCU width+4)” may be stored in the external memory. Through storing in the external memory in operation 1470, a filtering error occurring to a portion of the pixels located on the right side portion and the bottom of the LCU may be replaced with normal pixel values.

According to an exemplary embodiment, the in-loop filter may allow concurrent implementation of deblocking filtering and sample adaptive offset filtering based on LCUs.

According to an exemplary embodiment, the in-loop filter may pixel values stored in an internal memory in image reconstruction may be used for in-loop filtering since image reconstruction, deblocking filtering, and sample adaptive offset filtering are based on LCUs.

According to an exemplary embodiment, the in-loop filter may reduce an external memory access bandwidth by performing a succession of deblocking filtering and sample adaptive offset filtering concurrently with image reconstruction based on LCUs. In particular, since image reconstruction, deblocking filtering, and sample adaptive offset filtering are based on LCUs, the reconstructed LCU may be stored in an internal memory, so that external memory access may be minimized. Also, a portion of areas of an LCU to be filtered may be stored in a buffer during in-loop filtering, and when additional filtering is performed, external memory access may be reduced.

The methods described above may be recorded, stored, or fixed in one or more non-transitory computer-readable storage media that includes program instructions to be implemented by a computer to cause at least one processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard discs, floppy discs, and magnetic tape; optical media such as CD ROM discs, DVDs and Blu-rays; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a non-transitory computer-readable storage medium may be distributed among computer systems connected through a network and non-transitory computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An in-loop filter comprising:
an external memory to store decoded frames;
an internal memory to store pixels in use for deblocking filtering and sample adaptive offset filtering;
a horizontal deblocking filter to perform deblocking filtering on input pixels in a horizontal direction with respect to vertical edge boundaries within an input area, using a largest coding unit (LCU) and pixels adjacent to the LCU among the pixels stored in the internal memory;
a vertical deblocking filter to perform deblocking filtering in a vertical direction with respect to horizontal edge boundaries within the input area, using the pixels to which the deblocking filtering is applied in the horizontal direction; and
a sample adaptive offset filter to perform sample adaptive offset filtering using the pixels to which the deblocking filtering is applied in the horizontal direction within the input area.

2. The in-loop filter of claim 1, wherein the vertical deblocking filter performs the deblocking filtering using pixels located on a left side portion, an upper left side portion, and an upper side portion of the LCU among the pixels adjacent to the LCU.

3. The in-loop filter of claim 1, wherein the external memory stores reference pixel values to be used for in-loop filtering when the in-loop filtering is performed based on LCUs.

4. The in-loop filter of claim 1, wherein the internal memory loads pixels used for filtering from the external memory, based on LCUs when a high efficiency video coding (HEVC) decoder performs deblocking filtering and sample adaptive offset filtering based on frames in a sequential order, after performing image reconstruction based on frames.

5. The in-loop filter of claim 1, wherein the internal memory stores a portion of the pixels within the LCU to be used for in-loop filtering of a next LCU.

6. The in-loop filter of claim 1, wherein the external memory stores a portion of the pixels within the LCU to be used for in-loop filtering of a next LCU in a case in which a size limit exists for the internal memory.

7. The in-loop filter of claim 1, wherein at least one memory of the internal memory and the external memory stores a pixel area to be referred to for performing the deblocking filtering and the sample adaptive offset filtering, and re-uses the stored pixel area.

8. The in-loop filter of claim 7, wherein at least one memory of the internal memory and the external memory backs up a pixel area having a size determined based on an LCU height or an LCU width.

9. The in-loop filter of claim 8, wherein at least one memory of the internal memory and the external memory backs up a pixel area having a size determined based on an LCU height on a right side portion of the LCU, or a pixel area having a size determined based on an LCU width on a bottom of the LCU.

10. The in-loop filter of claim 9, wherein at least one memory of the internal memory and the external memory backs up a pixel area having a size determined based on an LCU height in a right side portion of the LCU, using a double buffer.

11. The in-loop filter of claim 9, wherein at least one memory of the internal memory and the external memory backs up a pixel area having a size determined based on an LCU width on a bottom of the LCU, using at least one of a double buffer and a triple buffer.

12. The in-loop filter of claim 1, wherein at least one memory of the internal memory and the external memory stores a line buffer,
at least one of the horizontal deblocking filter and the vertical deblocking filter performs deblocking filtering based on LCUs using the line buffer, and
the sample adaptive offset filter performs sample adaptive offset filtering based on LCUs.

13. The in-loop filter of claim 12, wherein at least one memory of the internal memory and the external memory stores an area having a size determined based on an image width in the line buffer, and updates the line buffer per line of the LCU.

14. An in-loop filtering method comprising:
storing decoded frames in an external memory;
storing pixels in use for deblocking filtering and sample adaptive offset filtering in an internal memory;
performing, using a horizontal deblocking filter, deblocking filtering on input pixels in a horizontal direction with respect to vertical edge boundaries within an input area, using a largest coding unit (LCU) and pixels adjacent to the LCU among the pixels stored in the internal memory;
performing, using a vertical deblocking filter, deblocking filtering in a vertical direction with respect to horizontal edge boundaries within the input area, using the pixels to which the deblocking filtering in the horizontal direction is applied; and
performing, using a sample adaptive offset filter, sample adaptive offset filtering using the pixels to which the deblocking filtering in the horizontal direction is applied within the input area.

15. The method of claim 14, wherein the deblocking filtering in the vertical direction comprises performing the deblocking filtering using pixels located on a left side portion, an upper left side portion, and an upper side portion of the LCU among the pixels adjacent to the LCU.

16. The method of claim 14, further comprising:
storing, using the external memory, reference pixel values to be used for in-loop filtering when the in-loop filtering is performed based on LCUs.

17. The method of claim 14, comprising:
loading, using the internal memory, pixels used for filtering from the external memory, based on LCUs when a high efficiency video coding (HEVC) decoder performs deblocking filtering and sample adaptive offset filtering based on frames in a sequential order, after reconstructing an image based on frames.

18. A non-transitory computer-readable medium comprising a program for instructing a computer to perform the method of claim 14.

19. The in-loop filter of claim 8, wherein the horizontal and deblocking filters each performs deblocking filtering on a pixel area having a size of the LCU height+5 pixels and the LCU width+5 pixels, and wherein the sample adaptive offset filter performs the sample adaptive offset filtering on a pixel area having a size of the LCU height+4 pixels and the LCU width+4 pixels.

20. The in-loop filter of claim 19, wherein the pixel area having a size of the LCU height+4 pixels and the LCU width+4 pixels is stored in the external memory.
